(19) United States
(12) Patent Application Publication
(10) Pub. No.: US 2004/0002963 A1
(43) Pub. Date: Jan. 1, 2004

(54) Resolving query terms based on time of submission

(76) Inventor: Laurence H. Cynkin, Kensington, MD (US)

Correspondence Address: FISH & RICHARDSON P.C., 1425 K STREET, N.W., 11TH FLOOR, WASHINGTON, DC, 20005-3500, US

(21) Appl. No.: 10/208,202

(22) Filed: Jul. 31, 2002

Related U.S. Application Data
(60) Provisional application No. 60/391,930, filed on Jun. 28, 2002.

(51) Int. Cl. G06F 17/30

(52) U.S. Cl. 707/3

(57) ABSTRACT

Identifying electronic information based on a query term typically includes receiving at least one query term. A submission time for the query term is determined and the query term is resolved against electronic information within at least one electronic information store to determine whether one or more matches exist. A result is generated that accounts for the submission time.

### CROSS REFERENCE TO RELATED APPLICATIONS

This application claims priority from U.S. Provisional Application No. 60/391,930, filed Jun. 28, 2002, and titled “Resolving Query Terms Based on Time of Submission,” which is incorporated by reference.

### TECHNICAL FIELD

This document relates to resolving terms of a query based on the time of submission of the query.

### BACKGROUND

With the explosion of information on the Internet, it has become increasingly difficult to conduct a search on the Internet that returns results that are useful to the person conducting the search. Frequently, when a search is performed, the most useful and relevant results may be scattered and buried among many less relevant results.

### SUMMARY

In one general aspect, identifying electronic information based on a query term includes receiving at least one query term. A submission time for the query term is determined and the query term is resolved against electronic information within at least one electronic information store to determine whether one or more matches exist. A result is generated that accounts for the submission time.

Implementations may include one or more of the following features. For example, the query term and the submission time may be resolved against the electronic information to determine whether one or more matches exist. In one implementation, the query term and different submission times may be resolved against the electronic information and different results may be generated that account for the different submission times.

A display of the result may be organized based on the submission time. The electronic information may be filtered based on the submission time and the query term may be resolved against the filtered electronic information to determine whether one or more matches exist. Subcategories appropriate for the submission time may be selected to filter the electronic information based on the submission time. The result may be displayed.

The submission time may include a time of day, a month, a season, and/or a temporal event (e.g., a holiday).

The query term may be resolved by performing a keyword search using the query term. In one implementation, the query term may be resolved by performing a keyword search using the query term and the submission time. In another implementation, the query term may be resolved using a common name resolution protocol. In yet another implementation, the query term may be resolved by performing a search for recommended sites and a list of recommended web sites may be generated based on the submission time.

These general and specific aspects may be implemented using a system, a method, or a computer program, or any combination of systems, methods, and computer programs.

Other features will be apparent from the description and drawings, and from the claims.

### DESCRIPTION OF DRAWINGS

FIG. 1 is a block diagram of a communications system.

FIG. 2 is an expansion of the block diagram of FIG. 1.

FIG. 3 is a flow chart of an exemplary process for identifying electronic information implemented by a communications system such as the communications system of FIGS. 1 and 2.

FIG. 4 is an exemplary implementation of the process of FIG. 3.

FIG. 5 is a flow chart of an exemplary process for identifying electronic information implemented by a communications system such as the communications system of FIGS. 1 and 2.

FIG. 6 is an exemplary implementation of the process of FIG. 5.

FIG. 7 is a flow chart of an exemplary process for identifying electronic information implemented by a communications system such as the communications system of FIGS. 1 and 2.

FIG. 8 is an exemplary implementation of the process of FIG. 7.

Like reference symbols in the various drawings may indicate like elements.

### DETAILED DESCRIPTION

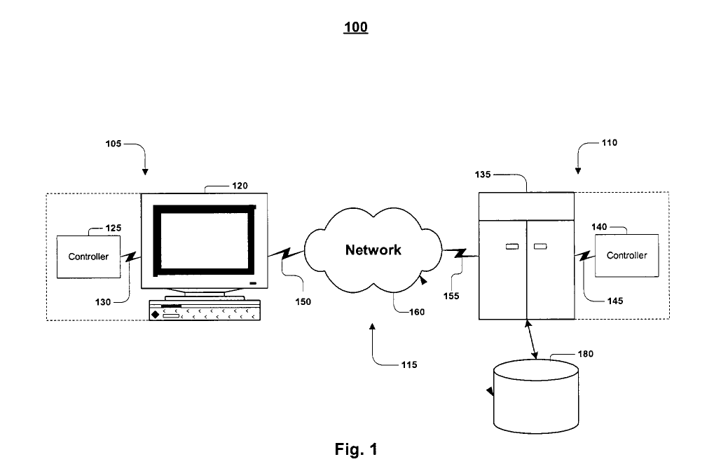

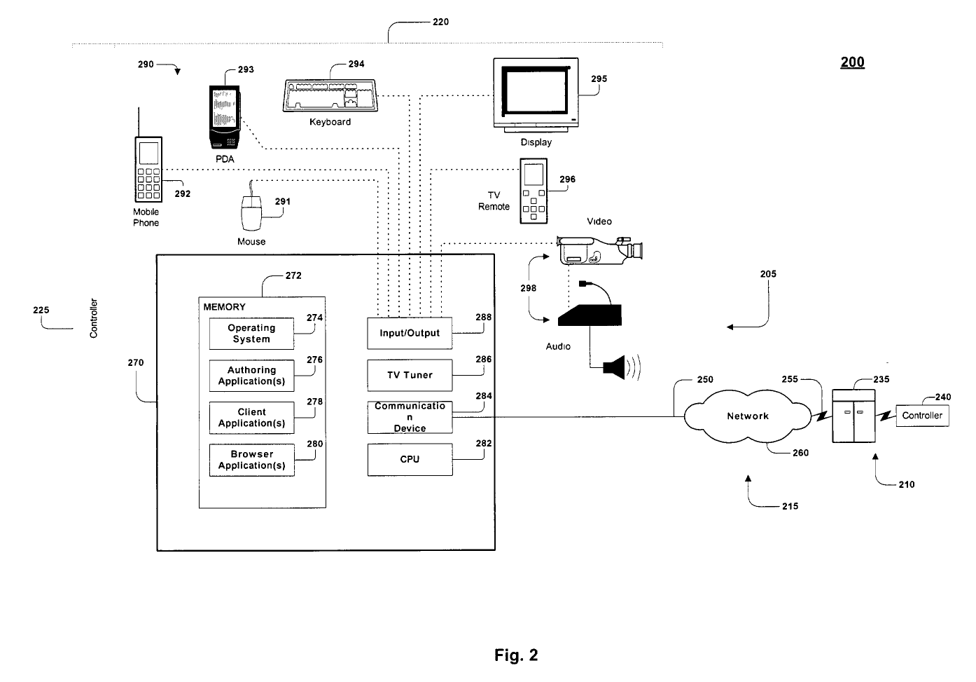

For illustrative purposes, FIGS. 1 and 2 show an example of a communications system for implementing techniques for transferring electronic data. For brevity, several elements in the figures described below are represented as monolithic entities. However, as would be understood by one skilled in the art, these elements each may include numerous interconnected computers and components designed to perform a set of specified operations and/or may be dedicated to a particular geographical region.

Referring to FIG. 1, a communications system 100 is capable of delivering and exchanging data between a requester system 105 and a provider system 110 through a communications link 115. The requestor system 105 may include a client system and the provider system 110 may include a host system. The requestor system 105 typically includes one or more requester devices 120 and/or requester controllers 125, and the provider system 110 typically includes one or more provider devices 135 and/or provider controllers 140. For example, the requestor system 105 or the provider system 110 may include one or more general-purpose computers (e.g., personal computers), one or more special-purpose computers (e.g., devices specifically programmed to communicate with each other and/or the requestor system 105 or the provider system 110), or a combination of one or more general-purpose computers and one or more special-purpose computers. The requester system 105 and the provider system 110 may be arranged to operate within or in concert with one or more other systems, such as, for example, one or more LANs (“Local Area Networks”) and/or one or more WANs (“Wide Area Networks”).

The requestor device 120 (or the provider device 135) is generally capable of executing instructions under the command of a requestor controller 125 (or a provider controller 140). The requestor device 120 (or the provider device 135) is connected to the requestor controller 125 (or the provider controller 140) by a wired or wireless data pathway 130 or 145 capable of delivering data.

Each of the requestor device 120, the requestor controller 125, the provider device 135, and the provider controller 140 typically includes one or more hardware components and/or software components. An example of a requester device 120 or a provider device 135 is a general-purpose computer (e.g., a personal computer) capable of responding to and executing instructions in a defined manner. Other examples include a special-purpose computer, a workstation, a server, a device, a component, other physical or virtual equipment or some combination thereof capable of responding to and executing instructions. The requestor device 120 and the provider device 135 may include devices that are capable of peer-to-peer communications.

An example of a requestor controller 125 or a provider controller 140 is a software application loaded on the requester device 120 or the provider device 135 for commanding and directing communications enabled by the requester device 120 or the provider device 135. Other examples include a program, a piece of code, an instruction, a device, a computer, a computer system, or a combination thereof, for independently or collectively instructing the requestor device 120 or the provider device 135 to interact and operate as described. The requestor controller 125 and the provider controller 140 may be embodied permanently or temporarily in any type of machine, component, physical or virtual equipment, storage medium, or propagated signal capable of providing instructions to the requester device 120 or the provider device 135.

The communications link 115 typically includes a delivery network 160 that provides direct or indirect communication between the requester system 105 and the provider system 110, irrespective of physical separation. Examples of a delivery network 160 include the Internet, the World Wide Web, WANs, LANs, analog or digital wired and wireless telephone networks (e.g., PSTN, ISDN, and xDSL), radio, television, cable, satellite, and/ or any other delivery mechanism for carrying data. The communications link 115 may include communication pathways 150 and 155 that enable communications through the one or more delivery networks 160 described above. Each of the communication pathways 150 and 155 may include, for example, a wired, wireless, cable or satellite communication pathway.

An electronic information store 180 may be connected to the provider system 110, included as a component of the provider system 110, and/or connected to the delivery network 160. The electronic information store 180 may be a repository for electronic information that may be formatted in an indexed and/or searchable format.

FIG. 2 illustrates a communications system 200 including a requester system 205 that communicates with a provider system 210 through a communications link 215. Requestor system 205 typically includes one or more requestor devices 220 and one or more requestor controllers 225 for controlling the requester devices 220. Provider system 210 typically includes one or more provider devices 235 and one or more provider controllers 240 for controlling the provider devices 235. The communications link 215 may include communication pathways 250 and 255 that enable communications through the one or more delivery networks 260.

Examples of each element within the communications system of FIG. 2 are broadly described above with respect to FIG. 1. In particular, the provider system 210 and communications link 215 typically have attributes comparable to and illustrate possible implementations of those described with respect to the provider system 110 and the communications link 115 of FIG. 1. Likewise, the requestor system 205 of FIG. 2 typically has attributes comparable to and illustrates one possible implementation of the requestor system 105 of FIG. 1.

The requestor device 220 typically includes a general-purpose computer 270 having an internal or external storage 272 for storing data and programs such as an operating system 274 (e.g., Disk Operating System (DOS), Windows™, Windows 95™, Windows 98™, Windows 2000™, Windows Me™, Windows XP™, Windows NT™, OS 9™, OS X™, or Linux™) and one or more application programs. Examples of application programs include authoring applications 276 (e.g., word processing programs, database programs, spreadsheet programs, or graphics programs) capable of generating documents or other electronic content; client applications 278 (e.g., America Online (AOL) client, CompuServe client, America Online Instant Messenger (AIM) client, AOL Television (TV) client, or Internet service provider (ISP client)) capable of communicating with other computer users, accessing various computer resources, and viewing, creating, or otherwise manipulating electronic content; and browser applications 280 (e.g., Netscape's Navigator™ or Microsoft's Internet Explorer™) capable of rendering standard Internet content.

The general-purpose computer 270 also includes a central processing unit (CPU) 282 for executing instructions in response to commands from the requestor controller 225. In one implementation, the requestor controller 225 includes one or more of the application programs installed on the internal or external storage 272 of the general-purpose computer 270. In another implementation, the requester controller 225 includes application programs externally stored in and performed by one or more device(s) external to the general-purpose computer 270.

The general-purpose computer typically will include a communication device 284 for sending and receiving data. One example of the communication device 284 is a modem. Other examples include a transceiver, a set-top box, a communication card, a satellite dish, an antenna, or another network adapter capable of transmitting and receiving data over the communications link 215 through a wired or wireless data pathway 250. The general-purpose computer 270 also may include a TV tuner 286 for receiving television programming in the form of broadcast, satellite, and/or cable TV signals. As a result, the requester device 220 can selectively and/or simultaneously display network content received by the communications device 284 and television programming content received by the TV tuner 286.

The general-purpose computer 270 typically will include an input/output interface 288 for wired or wireless connection to various peripheral devices 290. Examples of peripheral devices 290 include, but are not limited to, a mouse 291, a mobile phone 292, a personal digital assistant 293 (PDA), an MP3 player (not shown), a keyboard 294, a display monitor 295 with or without a touch screen input, a TV remote control 296 for receiving information from and rendering information to subscribers, and an audiovisual input device 298.

Although FIG. 2 illustrates devices such as a mobile telephone 292, a PDA 293, and a TV remote control 296 as being peripheral with respect to the general-purpose computer 270, in another implementation, one or more devices of this or similar type may themselves include the functionality of the general-purpose computer 270 and operate as the requestor device 220. For example, the mobile phone 292, the PDA 293, or an MP3 player may include computing and networking capabilities and function as a requestor device 220 by accessing the delivery network 260 and communicating with the provider system 210. Furthermore, the requestor system 205 may include one, some or all of the components and devices described above.

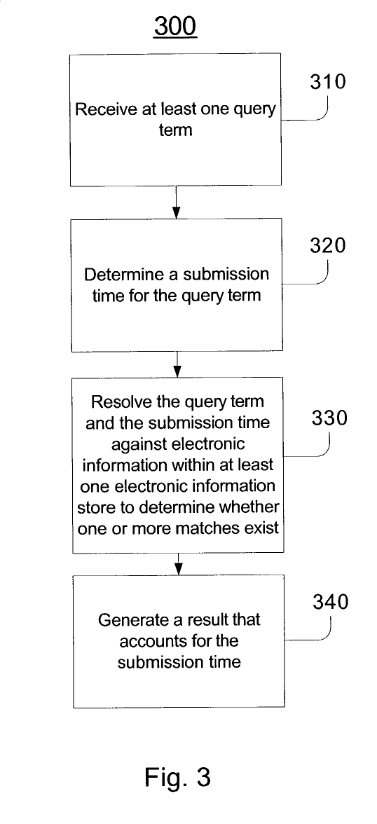

FIG. 3 illustrates an exemplary process 300 for identifying electronic information based on a query term. Process 300 may be used to resolve query terms for a search for electronic information (e.g., a search for information on the Internet or a search of proprietary electronic information) and/or a keyword search for electronic information. Process 300 typically includes receiving at least one query term (step 310), determining a submission time for the query term (step 320), resolving the query term against electronic information within at least one electronic information store to determine whether one or more matches exist (step 330), and generating a result that accounts for the submission time (step 340).

At least one query term may be received (step 3 1 0). When more than one query term is received, the query terms may be grouped by default as a single string, or may be grouped in other ways. Query terms typically are received from a requestor system 105 or 205 as shown and described in FIGS. 1 and 2. Query terms generally include text defined by letters and/or numbers. However, a query term also may include other searchable content, such as symbols, other alphanumeric characters, and geometric constructs (e.g., arcs); Boolean operators (e.g., AND, OR, ADJ, NOT, NEAR) generally used to define relationships between query terms; parentheses and quotation marks generally used to indicate precision and to group query terms; wild card characters (e.g., ? and *) generally used to represent a portion of a query term; and concept operators (e.g., !) generally used to broaden a query term or phrase to a list of related words related to the query term or phrase in order to resolve the query term against electronic information using these related words. Other information may accompany the query terms that apply to the query and/or to a user who enters the query that may further refine the query.

In addition to receiving at least one query term (step 3 1 0), a submission time of the query term is determined (step 320). The submission time may include a time at which the query term was entered by a user into a requestor system 105 or 205, a time at which the query term was communicated by the requestor system 105 or 205 to the provider system 110 or 210 and/or the electronic information store 180, or a time at which the query term was received by the provider system 110 or 210 and/or the electronic information store 180.

The submission time may include a time of the day, such as, for example, the hour of the day or other type of time designation (e.g., “AM”, “PM”, morning, noon, evening, night, daytime, or after hours). The submission time also may include a month or other period of the year, such as, for example, a season of the year such as Spring, Summer, Fall, or Winter. The submission of time also may include other temporal events, such as, for example, holidays (e.g., Halloween, Easter, Thanksgiving, Mother's Day, etc.), and other temporal events, such as the time of the year for political elections. Other types or designations relating to time also may be used.

The submission time may be determined (step 320) in one or more ways. For example, in one implementation, the submission time may be determined by using a computer clock or other time measuring device associated with the requestor system 105 or 205 or the provider system 110 or 210. The submission time initially may be determined (step 320) using the computer clock and then may be converted from the clock time to another time period or time designation, such as those described above. In another implementation, the submission time may be determined (step 320) by a user entering or designating the submission time in a graphical user interface (GUI) when entering a query term that may be part of a search string or the submission time may be selected from a GUI radio button. In this case, the submission time may be the time at which the user entered the query, one of the other submission times described above, or a time on which the user desires the results of resolving the query to be based.

The query term is resolved against electronic information within at least one electronic information store to determine whether one or more matches exist (step 330). The electronic information may include any type of information stored and/or maintained by an electronic information store that may be indexed and/or searchable.

In one implementation, at step 330, the submission time also may be resolved against electronic information within the electronic information store. For example, the electronic information may be designated, associated, identified, and/or tagged (e.g., a metatag that has been manually entered or automatically generated) with a time reference such that the determined submission time (step 320) may be resolved against the time reference along with the query term. In this instance, different results to the same query term may be obtained based on different submission times. For example, a website may include a GUI to enter a query term to be resolved against the content within the website. If the website is for a restaurant, and the query term “menu” is entered, the query term may resolve to a match for a breakfast menu if the submission time is in the morning. However, if the submission time for the same query is a later time than the earlier submission time, then the same query term may resolve to a match for a lunch or dinner menu.

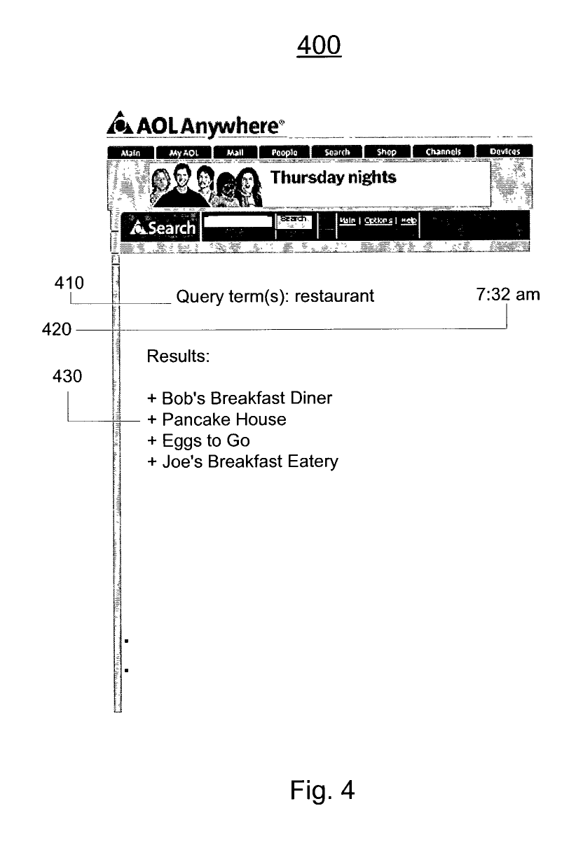

FIG. 4 illustrates an exemplary screen shot 400 implementation of process 300 of FIG. 3. In this example, screen shot 400 illustrates a GUI where the query term “restaurant” 410 has been received for resolving against the electronic content accessible through the GUI. In this example, the submission time was determined to be “7:32 am” 420. The query term 410 and the submission time 420 are resolved against the electronic content to determine whether matches exist and to generate a result 430 that accounts for the submission time. In this case, the submission time 420 is accounted for during the resolution step.

A result is generated that accounts for the submission time (step 340). The result may be filtered and/or ranked based on the submission time, and the result may be displayed.

As described, the query term may be resolved (step 330) by performing a keyword search using the query term. The keyword search may be enhanced using the submission time as additional search criteria, as described above with respect to FIG. 4. In another implementation, the query may be resolved (step 330) by performing a search for recommended websites, with or without taking submission time into consideration, and filtering the result of the search based on the submission time either before or after the search. Recommended web sites may include premium web sites and/or secondary search results which may accompany a more general listing of non-premium web sites.

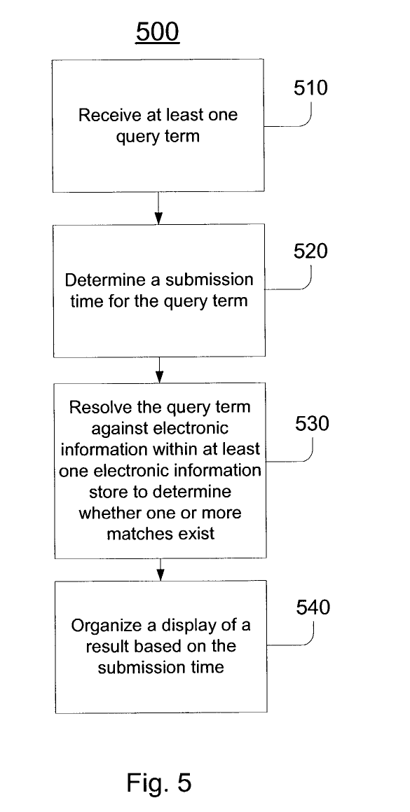

FIG. 5 illustrates another exemplary process 500 for identifying electronic information based on a query term, where submission time is used to organize search results. In this exemplary implementation, process 500 typically includes receiving at least one query term (step 510), determining a submission time (step 520), resolving the query term against electronic information within at least one electronic information store to determine whether one or more matches exist (step 530), and organizing a display of a result based on the submission time (step 540).

In exemplary process 500, steps 510 and 520 of FIG. 5 are comparable to steps 310 and 320 described above with respect to FIG. 3. In this exemplary implementation, the query term is resolved against the electronic information (step 530) and any resulting matches are organized based on the submission time (step 540). For example, the result may be organized by filtering and/or ranking the results based on the submission time (step 540).

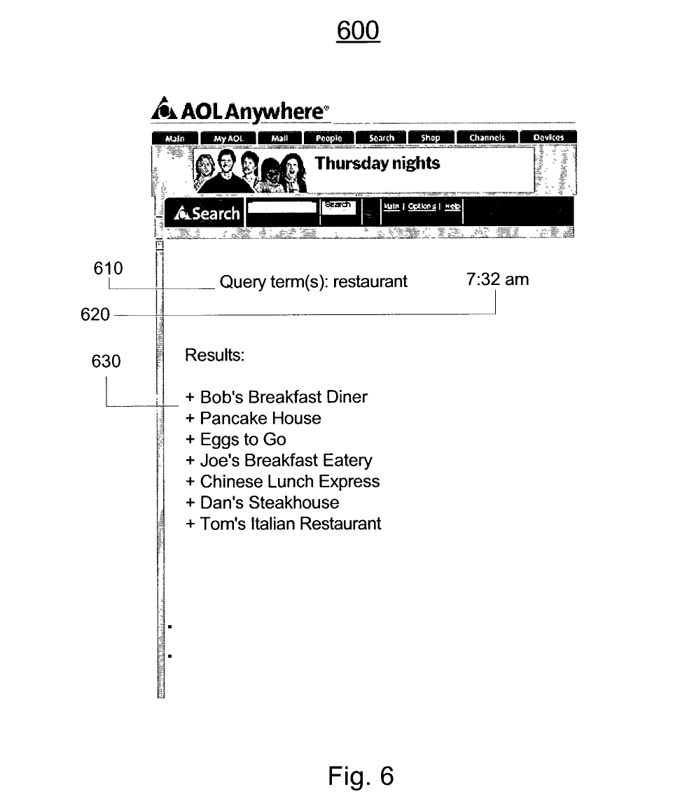

FIG. 6 illustrates an exemplary screen shot 600 implementation of process 500 of FIG. 5. In this example, screen shot 600 illustrates a GUI where the query term “restaurant” 610 has been received for resolving against the electronic content accessible through the GUI. In this example, the submission time was determined to be “7:32am” 620 and is not used to filter the electronic content. Instead the query term “restaurant” 610 is resolved against the electronic content and then the submission time 620 is used to organize any resulting matches by organizing and/or ranking the results. In this example, the results 630 are ranked based on the submission time such that breakfast restaurants are at the top of the results list and lunch and dinner restaurants are ranked after the breakfast restaurants.

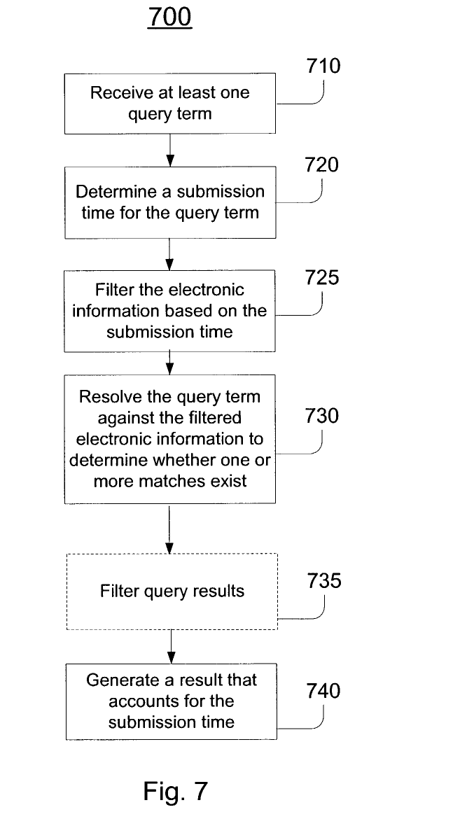

FIG. 7 illustrates another exemplary process 700 for identifying electronic information based on a query term in which submission time is used as a filter. In this exemplary implementation, process 700 typically includes receiving at least one query term (step 710), determining a submission time (step 720), filtering the electronic information based on the submission time (step 725), resolving the query term against the filtered electronic information to determine whether one or more matches exist (step 730), and generating a result that accounts for the submission time (step 740).

In exemplary process 700, steps 710, 720, and 740 of FIG. 7 are comparable to steps 310, 320, and 340 described above with respect to FIG. 3.

In this exemplary implementation, the submission time may be used to narrow the field of candidates against which the query term will be applied before resolution of the query term (step 725). For instance, subcategories appropriate for the submission time may be selected to filter the electronic information based on the submission time. A similar approach may involve using the submission time to filter results of a search that may or may not have been conducted based on submission time (see optional step 735 that may be used instead of step 725). In this manner, the results include only the electronic information that matches the submission time.

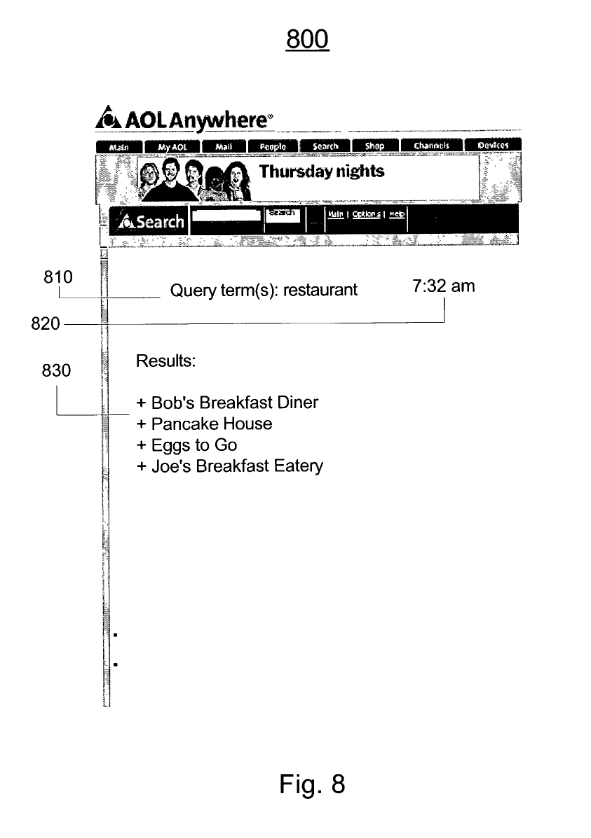

FIG. 8 illustrates an exemplary screen shot 800 implementation of process 700 of FIG. 7. In this example, screen shot 800 illustrates a GUI where the query term “restaurant” 810 has been received for resolving against the electronic content accessible through the GUI. In this example, the submission time was determined to be “7:32 am” 820. The submission time 820 is used to filter the electronic content based on the submission time before the query term “restaurant” 810 is resolved against the electronic content. After the submission time 820 is used to filter the electronic content, then the query term 810 is resolved against the electronic content. In this example, the results 830 are then displayed where the submission time was taken into account before the query term was resolved.

In another exemplary implementation, a search engine may resolve a query term and generate a result based on the submission time for the query. The search engine may resolve the same query and may yield a different result based on different submission times for the query.

The described systems, methods, and techniques may be implemented in digital electronic circuitry, computer hardware, firmware, software, or in combinations of these elements. Apparatus embodying these techniques may include appropriate input and output devices, a computer processor, and a computer program product tangibly embodied in a machine-readable storage device for execution by a programmable processor. A process embodying these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

It will be understood that various modifications may be made without departing from the spirit and scope of the claims. For example, query terms may be resolved based on a submission time in a system and/or method that uses the Common Name Resolution Protocol (CNRP). Further, advantageous results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. A method for identifying electronic information based on a query term, the method comprising:
receiving at least one query term;
determining a submission time for the query term;
resolving the query term against electronic information within at least one electronic information store to determine whether one or more matches exist; and
generating a result that accounts for the submission time.

2. The method as in claim 1 wherein resolving the query term includes resolving the query term and the submission time against the electronic information to determine whether one or more matches exist.

3. The method as in claim 2 wherein:
resolving the query time and the submission time includes resolving the query term and different submission times against the electronic information; and
generating the result includes generating different results that account for the different submission times.

4. The method as in claim 1 wherein generating the result includes organizing a display of the result based on the submission time.

5. The method as in claim 1 further comprising filtering the electronic information based on the submission time, wherein resolving the query term includes resolving the query term against the filtered electronic information to determine whether one or more matches exist.

6. The method as in claim 5 wherein filtering the electronic information based on the submission time includes selecting subcategories appropriate for the submission time.

7. The method as in claim 1 wherein generating the result includes displaying the result.

8. The method as in claim 1 wherein the submission time includes a time of day.

9. The method as in claim 1 wherein the submission time includes a month.

10. The method as in claim 1 wherein the submission time includes a season.

11. The method as in claim 1 wherein the submission time includes a temporal event.

12. The method as in claim 11 wherein the temporal event includes a holiday.

13. The method as in claim 1 wherein resolving the query term includes performing a keyword search using the query term.

14. The method as in claim 1 wherein resolving the query term includes performing a keyword search using the query term and the submission time.

15. The method as in claim 1 wherein:
resolving the query term includes performing a search for recommended sites; and
generating the result includes generating a list of recommended web sites based on the submission time.

16. The method as in claim 1 wherein resolving the query term includes using a common name resolution protocol.

17. A computer program stored on a computer readable medium or a propagated signal for identifying electronic information based on a query term, comprising:
a receiving code segment that causes the computer to receive at least one query term;
a determining code segment that causes the computer to determine a submission time for the query term;
a resolving code segment that causes the computer to resolve the query term against electronic information within at least one electronic information store to determine whether one or more matches exist; and
a generating code segment that causes the computer to generate a result that accounts for the submission time.

18. The computer program of claim 17 wherein the resolving code segment causes the computer to resolve the query term and the submission time against the electronic information to determine whether one or more matches exist.

19. The computer program of claim 18 wherein:
the resolving code segment causes the computer to resolve the query term and different submission times against the electronic information; and
the generating code segment causes the computer to generate different results that account for the different submission times.

20. The computer program of claim 17 wherein the generating code segment causes the computer to organize a display of the result based on the submission time.

21. The computer program of claim 17 further comprising a filtering code segment that causes the computer to filter the electronic information based on the submission time, wherein the resolving code segment causes the computer to resolve the query term against the filtered electronic information to determine whether one or more matches exist.

22. The computer program of claim 21 wherein the filtering code segment causes the computer to select subcategories appropriate for the submission time.

23. The computer program of claim 17 wherein the generating code segment causes the computer to display the result.

24. The computer program of claim 17 wherein the submission time includes a time of day.

25. The computer program of claim 17 wherein the submission time includes a month.

26. The computer program of claim 17 wherein the submission time includes a season.

27. The computer program of claim 17 wherein the submission time includes a temporal event.

28. The computer program of claim 27 wherein the temporal event includes a holiday.

29. The computer program of claim 17 wherein the resolving code segment causes the computer to perform a keyword search using the query term.

30. The computer program of claim 17 wherein the resolving code segment causes the computer to perform a keyword search using the query term and the submission time.

31. The computer program of claim 17 wherein:
the resolving code segment causes the computer to perform a search for recommended sites; and
the generating code segment causes the computer to generate a list of recommended web sites based on the submission time.

32. The computer program of claim 17 wherein the resolving code segment causes the computer to use a common name resolution protocol.

33. A system for identifying electronic information based on a query term, comprising:
means for receiving at least one query term;
means for determining a submission time for the query term;
means for resolving the query term against electronic information within at least one electronic information store to determine whether one or more matches exist; and
means for generating a result that accounts for the submission time.

34. The system of claim 33 wherein the means for resolving the query term includes means for resolving the query term and the submission time against the electronic information to determine whether one or more matches exist.

35. The system of claim 34 wherein:
the means for resolving the query time and the submission time includes means for resolving the query term and different submission times against the electronic information; and
the means for generating the result includes means for generating different results that account for the different submission times.

36. The system of claim 33 wherein the means for generating the result includes means for organizing a display of the result based on the submission time.

37. The system of claim 33 further comprising means for filtering the electronic information based on the submission time, wherein the means for resolving the query term includes means for resolving the query term against the filtered electronic information to determine whether one or more matches exist.

38. The system of claim 37 wherein the means for filtering the electronic information based on the submission time includes means for selecting subcategories appropriate for the submission time.

39. The system of claim 33 wherein the means for generating the result includes means for displaying the result.

40. The system of claim 33 wherein the submission time includes a time of day.

41. The system of claim 33 wherein the submission time includes a month.

42. The system of claim 33 wherein the submission time includes a season.

43. The system of claim 33 wherein the submission time includes a temporal event.

44. The system of claim 43 wherein the temporal event includes a holiday.

45. The system of claim 33 wherein the means for resolving the query term includes means for performing a keyword search using the query term.

46. The system of claim 33 wherein the means for resolving the query term includes means for performing a keyword search using the query term and the submission time.

47. The system of claim 33 wherein:
the means for resolving the query term includes means for performing a search for recommended sites; and
the means for generating the result includes means for generating a list of recommended web sites based on the submission time.

48. The system of claim 33 wherein the means for resolving the query term includes means for using a common name resolution protocol.
